(19) United States
(12) Patent Application Publication
(10) Pub. No.: US 2003/0177628 A1
(43) Pub. Date: Sep. 25, 2003

(54) Cable ducting joiner

(76) Inventor: Mark Viklund, New Milford, CT (US)

Correspondence Address: CANTOR COLBURN, LLP, 55 GRIFFIN ROAD SOUTH, BLOOMFIELD, CT, 06002

(21) Appl. No.: 10/370,908

(22) Filed: Feb. 20, 2003

Related U.S. Application Data
(60) Provisional application No. 60/359,293, filed on Feb. 21, 2002.

(51) Int. Cl. B23P 11/00

(52) U.S. Cl. 29/428

(57) ABSTRACT

A cable ducting joiner for connecting cable ducts includes: a member having at least one side; at least one actuator disposed the side, the actuator having an open position and a closed position; and the actuator includes at least one gripper end that applies a pressure to the cable duct when the actuator is in the closed position and releases the pressure when the actuator is in the open position.

### CROSS-REFERENCE TO RELATED APPLICATIONS

The present application claims the benefit of the date of the earlier filed provisional application, having U.S. Provisional Application No. 60/359,293, filed on Feb. 21, 2002, which is incorporated herein in its entirety.

### BACKGROUND OF THE INVENTION

Existing cable ducting systems for cable (i.e., optical fiber cable) include duct channels, fittings, and joiners. The duct channels include solid straight sections that are used for horizontal routes for fiber optical cables. The straight sections are generally about 6.5 feet in length. There are also various types of fittings, which include up and down vertical elbows, vertical tees, and adapters. The elbows permit maneuvering over or under obstructions such as air conditioners, heaters, cable, or ladder racking. The tees are commonly used to drop the cables from a horizontal run, with other fibers continuing along the horizontal path. Adapters are used to maneuver left or right around obstructions.

Each of the various channels and fittings are mated together and held in place by joiners, which are generally u-shaped members. There are generally two types of cable ducting systems. The first type of cable ducting system employs hardware, such as nuts and bolts, to fasten each of the duct channels and fittings to the joiners. These hardware type cable ducting systems require the use of wrenches and take considerable time to assembly. The second type of cable ducting system employs a snap lock system. In the typical snap lock cable ducting systems, a detent or slot is required in the channel to receive the detent from the joiner. This requires expensive tooling and time spent by the installer on-site to form the slot in the duct or fitting. Also, the forming of the slot on-site requires considerable skill and accuracy. The integrity of the joint and damage to the fiber optic cable could result from an inaccurately formed slot. Finally, there are some slot-less cable ducting system, which are an improvement over the snap lock systems, however, those systems still require the use of a tool to activate the joiner.

### SUMMARY OF THE INVENTION

The above discussed and other drawbacks and deficiencies of the prior art are overcome or alleviated by a cable ducting joiner. In an exemplary embodiment, a cable ducting joiner for connecting cable ducts includes: a member having at least one side; at least one actuator disposed the side, the actuator having an open position and a closed position; and the actuator includes at least one gripper end that applies a pressure to the cable duct when the actuator is in the closed position and releases the pressure when the actuator is in the open position.

### BRIEF DESCRIPTION OF THE DRAWINGS

Referring now to the drawings wherein like elements are numbered alike in the several Figures:

FIG. 1 is a perspective view of a cable ducting joiner;

FIG. 2 is a front view of the cable ducting joiner of FIG. 1;

FIG. 3 is a side view of the cable ducting joiner of FIG. 1;

FIGS. 4 and 5 are top views of the cable ducting joiner of FIG. 1;

FIG. 6 is a perspective view of a side view of the cable ducting joiner of FIG. 1;

FIG. 7 is perspective view of the cable ducting joiner attached to a duct channel;

FIG. 8 is an alternative embodiment of the cable ducting joiner of FIG. 1;

FIG. 9 is an alternative embodiment of the cable ducting joiner of FIG. 1; and

FIG. 10 is an alternative embodiment of the cable ducting joiner of FIG. 1.

### DETAILED DESCRIPTION

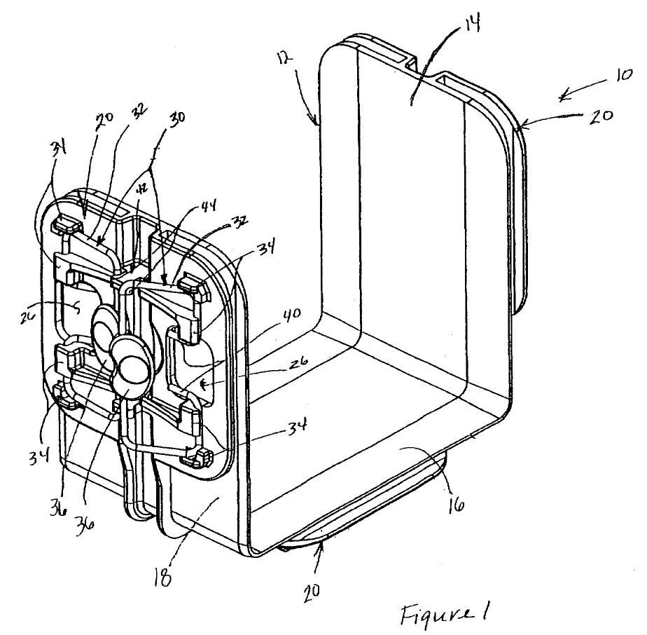

FIG. 1 depicts a cable ducting joiner 10 (joiner 10), which is preferably made from molded plastic. Joiner 10 is a u-shaped member 12 having a first side 14, a second side 16, and a third side 18. On each side 14, 16, and 18, there are two raised members 20, which are generally planar and parallel to sides 14, 16, and 18. A slot 24 is formed between side 14, 16, and 18 and raised members 20. In addition, each raised member 20 has an opening 26, which may be any shape and in the exemplary embodiment is illustrated as being square. An actuator 30 is located on and attached to each raised member 20.

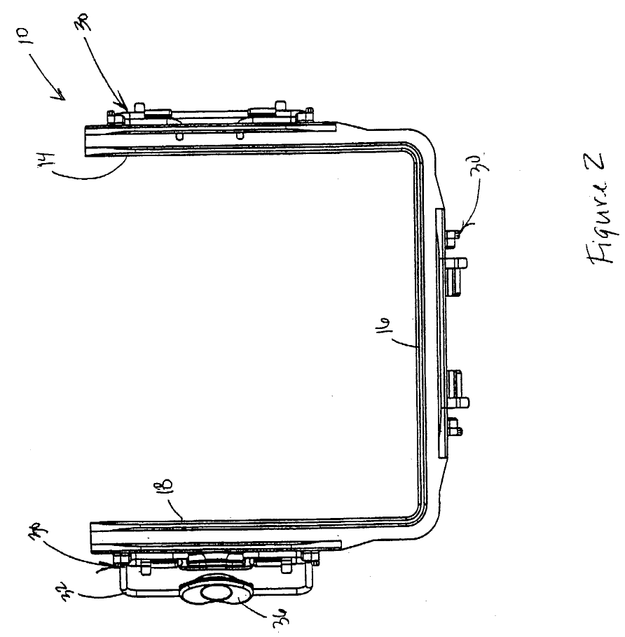

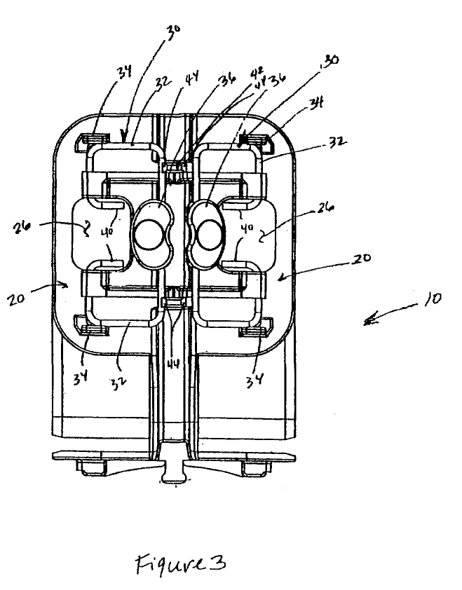

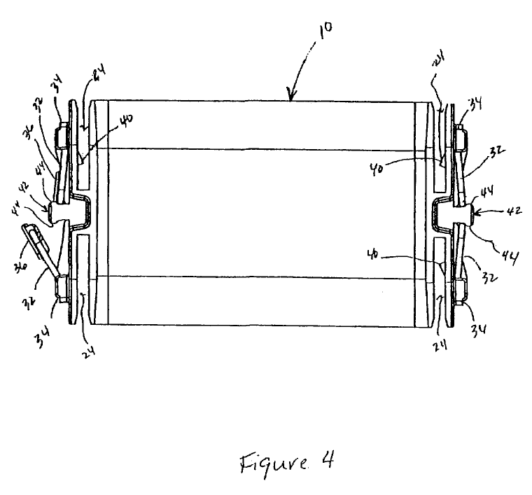

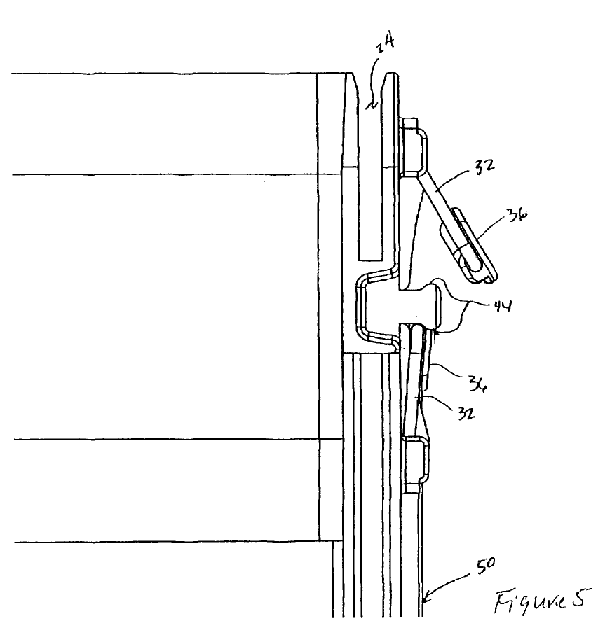

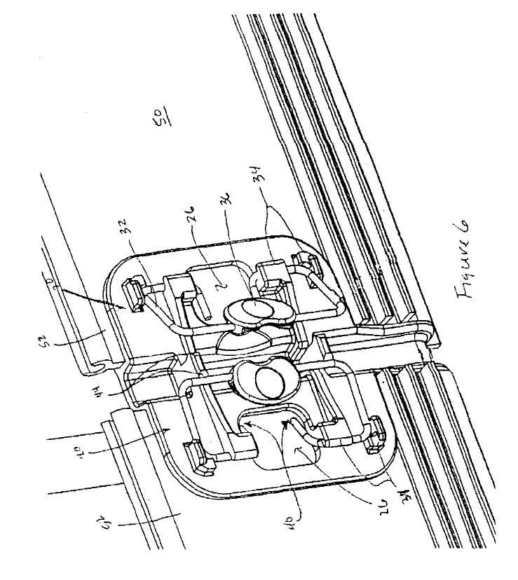

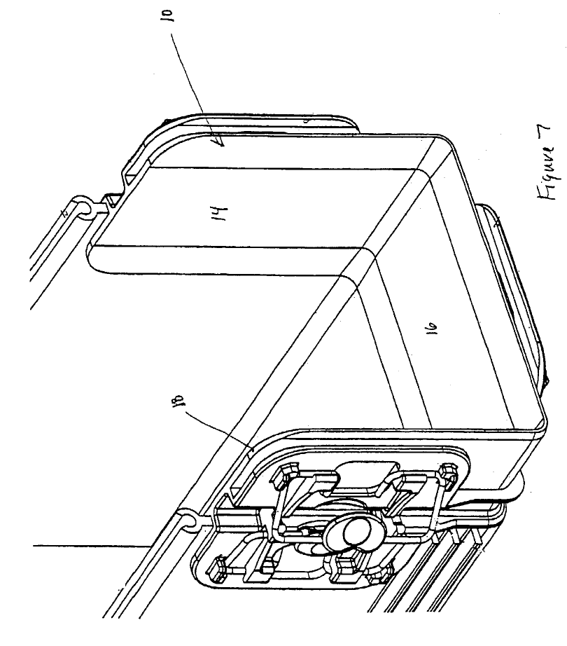

Referring to FIGS. 1-7, various views of joiner 10 are illustrated. Actuator 30 includes a wire 32, two pivot connection joints 34, and a push area 36. Wire 32 is shaped so that at least one and preferably two gripper ends 40 extend over opening 26. Gripper ends 40 are bent at an angle from wire 32. A center member 42 is located between each raised member 20 on each side 14, 16, and 18. Center member 42 has a tab 44 located on each side of center member 42. Wire 32 is in a closed or locked position when it is located underneath tab 44. When wire 32 is in the closed position, gripper ends 40 extend through opening 26.

Referring again to FIGS. 1-7, joiner 10 operates as follows. A duct channel and/or fitting 50 (collectively referred to as channel 50) are aligned with joiner 10 so that three walls 52 of channel 50 are aligned with sides 14, 16, and 18. The three walls 52 of channel 50 are inserted into slots 24 located on each side 14, 16, and 18. Walls 52 are initially held in place by a friction fit. An operator pushes on push area 36 and rotates wire 32 towards center member 42. As the push area 36 rotates towards center member 42, gripper end 40 rotates into opening 26. As the operator continues to move push area 36 toward center member 42, gripper end 40 continues to rotate through opening 26. Once wire 32 snaps under tab 44 and is in the closed position, gripper end 40 extends through opening 26 and pushes into wall 52. The shape and angle of gripper end 40 provides a grip to wall 52 of channel 50. Moreover, the angle of gripper end 40 provides additional grip to wall 52 if a load is placed on channel 50. Each of the three actuators 30 operates to secure each wall 52 in the same manner.

After channel 50 is secured, a second channel 50 can also be mated and secured to joiner 10 in the same manner. Thus, two separate channels 50 are each secured to joiner 10 separately.

Channel 50 can be removed from joiner 10 by pulling on pull area 36 so that wire 32 releases from under tab 44. Gripper end 40 rotates away from wall 52 and wall 52 can be pulled from slot 24. Each of the three actuators 30 operates to release each wall 52 in the same manner. After first channel 50 is removed, second channel 50 can be removed in the same manner.

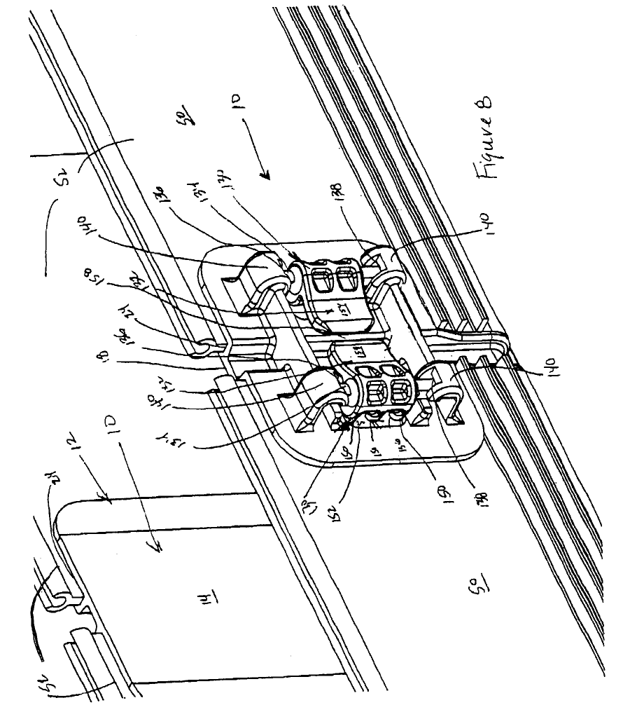

Referring to FIG. 8, an alternate exemplary embodiment of joiner 10 is illustrated. In this embodiment, joiner 10 is similar to the one depicted in FIGS. 1-7, except the actuator structure is different. An actuator 130 has a main body 132 that pivots on a bar 134. Bar 134 is secured at a first end 136 and a second end 138 by an end piece 140. Main body 132 includes metal blades 150 that extend through an opening 152 when actuator 130 is in the closed position. Metal blades 150 have a rounded shape. Main body 132 also has a push area 154 to move actuator 130 into and out of a closed or locked position. While the structure of actuator 130 is different from actuator 30, the two actuators operate in a similar manner.

Referring again to FIG. 8, joiner 10 operates as follows. Channel 50 is aligned with joiner 10 so that three walls 52 (only two shown) of channel 50 are aligned with sides 14, 16, and 18 (only two shown). The three walls 52 of channel 50 are inserted into slots 24 located on each side 14, 16, and 18. Walls 52 are initially held in place by a friction fit. An operator pushes on push area 154 and rotates main body 132 towards a center 158 of sides 14, 16, and 18. As push area 154 rotates towards center 158, blades 150 rotate into opening 152. As the operator continues to move push area 154 toward center 158, blades 150 continue to rotate through opening 152. As blades 150 extend through opening 152, there is pressure at a cam surface 156 between blades 150 and wall 52. The operator continues to press on push area 154 until blades 150 rotate past a point so that main body 132 snaps into a closed position. The shape of blades 150 holds wall 52 of channel 50 in place and also allows main body 132 to stay in a closed position. Each of the three actuators 130 operates to secure each wall 52 in the same manner.

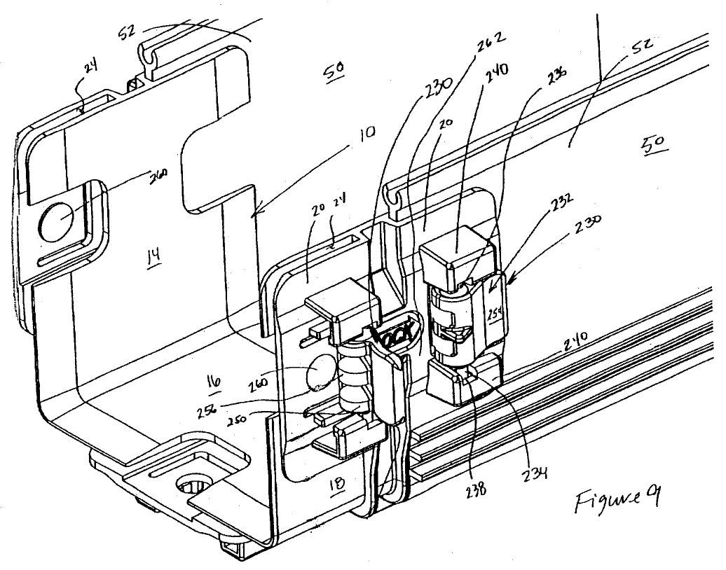

Referring to FIG. 9, an alternate exemplary embodiment of joiner 10 is illustrated. In this embodiment, joiner 10 has u-shaped member 12 with three sides 14, 16, and 18. On each side 14, 16, and 18, there are two raised members 20, which are generally planar and parallel to sides 14, 16, and 18. A slot 24 is formed between side 14, 16, and 18 and raised members 20.

Joiner 10 is similar to the one depicted in FIG. 8, except the actuator structure is different. An actuator 230 is attached to raised member 20 and has a main body 232 that pivots on a bar 234. Bar 234 is secured at a first end 236 and a second end 238 by an end piece 240. Main body 232 includes gripper ends or protrusions 250 that are rounded. Main body 232 also has a push area 254 to move actuator 230 into and out of a closed or locked position. On raised member 20, there is a pad 260, which may be rubber or metal. Pad 260 extends through raised member 20 so that it protrudes into slot 24.

Referring again to FIG. 9, joiner 10 operates as follows. Channel 50 is aligned with joiner 10 so that three walls 52 (only two shown) of channel 50 are aligned with sides 14, 16, and 18. The three walls 52 of channel 50 are inserted into slots 24 located on each side 14, 16, and 18. Walls 52 are initially held in place by a friction fit. An operator pushes on push area 254 and rotates main body 232 away from a center 262 of sides 14, 16, and 18. As push area 254 rotates away from center 262, protrusions 250 rotate so that a cam surface 256 of protrusions 250 pushes against pad 260, which then applies pressure to wall 52. The operator continues to press on push area 254 until protrusions 250 rotate past a point so that main body 232 snaps into a closed position. The shape of protrusions 250 applies pressure to pad 260, which then holds wall 52 of channel 50 in place and also allows main body 232 to stay in a closed position. Each of the three actuators 230 operates to secure each wall 52 in the same manner.

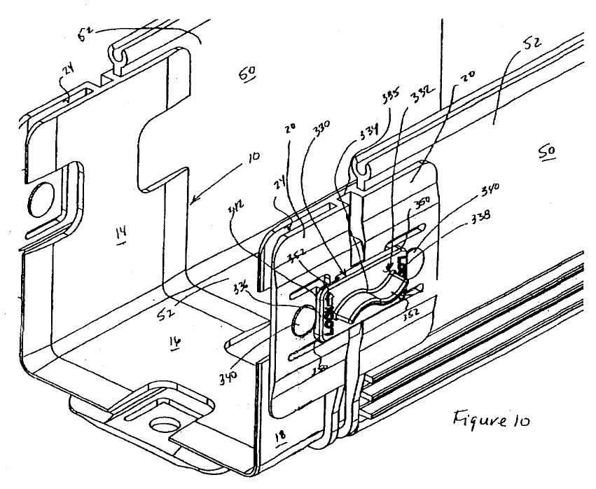

Referring to FIG. 10, an alternate exemplary embodiment of joiner 10 is illustrated. In this embodiment, joiner 10 has u-shaped member 12 with three sides 14, 16, and 18. On each side 14, 16, and 18, there are two raised members 20, which are generally planar and parallel to sides 14, 16, and 18. A slot 24 is formed between side 14, 16, and 18 and raised members 20.

Joiner 10 is similar to the one depicted in FIG. 9, except the actuator structure is different. An actuator 330 is attached to raised member 20 and has a main body 332 that rotates around a center point 334 of main body 332. In this embodiment, there is only one actuator 330 for both sides of joiner 10. As such, one actuator 330 is attached to both raised members 20, with center 334 of actuator 330 located at a center 335 of each side 14, 16, and 18.

Main body 330 has a first end 336 and a second end 338 that extend over a pad 340, which is made from metal or rubber. At both first and second ends 336 and 338 on a side 342 of main body 332 that faces pad 340, side 342 has a gripper end or sloped edge (not shown). As such, at a first corner of both first and second ends 336 and 338, main body 332 is thicker than at a second corner of both first and second ends 336 and 338. Main body 332 also has a turn handle 354, so that operator can rotate main body 332 around center 334.

Referring again to FIG. 10, joiner 10 operates as follows. Channel 50 is aligned with joiner 10 so that three walls 52 of channel 50 are aligned with sides 14, 16, and 18. The three walls 52 of channel 50 are inserted into slots 24 located on each side 14, 16, and 18. Walls 52 are initially held in place by a friction fit. An operator grasps turn handle 354 and rotates handle 354 so that main body 332 rotates in a clockwise direction around center 334. As main body 332 rotates in a clockwise direction, the sloped edge (not shown) pushes against pad 340 with more pressure being applied against pad 340 the further main body 332 rotates around center 334. Once first corner 350 is located over pad 340, actuator 330 is in the closed or locked position. Each of the three actuators 330 operates to secure each wall 52 in the same manner.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A cable ducting joiner for connecting cable ducts comprising:
a member having at least one side;
at least one actuator disposed said side, said actuator having an open position and a closed position; and
said actuator includes at least one gripper end that applies a pressure to the cable duct when said actuator is in said closed position and releases said pressure when said actuator is in said open position.

2. The joiner of claim 1, further comprising:
at least one raised member attached to said side; and
a space for receiving the cable duct is disposed between said raised member and said side, said raised member includes an opening in which said gripper end extends through said opening and contacts the cable duct when said actuator is in said closed position.

3. The joiner of claim 2, wherein said actuator includes a wire pivotally connected to said raised member and said gripper end is disposed at an end of said wire, said wire pivots between said open position and said closed position.

4. The joiner of claim 3, wherein said wire includes a push area.

5. The joiner of claim 3, further comprising a center member having a tab, said wire is disposed under said tab when said actuator is in said closed position.

6. The joiner of claim 2, wherein said actuator includes a main body having a blade, said main body is pivotally connected to said raised member, said main body rotates between said open position and said closed position.

7. The joiner of claim 6, wherein said gripper end is disposed at a cam surface of said blade.

8. The joiner of claim 6, further comprising a center member having a tab, said main body is disposed under said tab when said actuator is in said closed position.

9. The joiner of claim 1, further comprising:
at least one raised member attached to said side; and
a space for receiving the cable duct is disposed between said raised member and said side, said raised member includes an opening in which said gripper end extends through said opening and contacts the cable duct when said actuator is in said closed position.

10. The joiner of claim 1, wherein said member includes a second side and a third side, a second actuator is disposed at said second side, and a third actuator is disposed at said third side.

11. The joiner of claim 1, further comprising a secondary actuator disposed at said side.

12. The joiner of claim 1, further comprising:
at least one raised member attached to said side; and
a space for receiving the cable duct is disposed between said raised member and said side, said raised member includes a pad.

13. The joiner of claim 11, wherein when said actuator is in said closed position, said gripper end pushes against said pad so that said pad contacts the cable duct.

14. The joiner of claim 11, wherein said actuator includes a main body having a sloped edge that is pivotally attached to said raised member, said gripper end is said sloped edge, said main body rotates between said open position and said closed position.

15. The joiner of claim 13, wherein said main body include a handle.

16. A method of joining cable ducts, the method comprising:
sliding a first cable duct end between a side and a raised member of the joiner;
sliding a second cable duct end between said and a second raised member of the joiner;
engaging a first actuator disposed at said first raised member without using tools so that said first cable duct end is secured; and
engaging a second actuator disposed at said second raised member without using tools so that said second cable duct end is secured.
